(19) United States
(12) Patent Application Publication
(10) Pub. No.: US 2015/0249333 A1
(43) Pub. Date: Sep. 3, 2015

(54) COMPLEX PROTECTION DEVICE OF BLOCKING THE ABNORMAL STATE OF CURRENT AND VOLTAGE

(71) Applicant: SMART ELECTRONICS INC., Ulsan (KR)

(72) Inventors: Doo Won KANG, Anyang-si (KR); Hyun Chang KIM, Ulsan (KR); Kwang Beom KIM, Yangsan-si (KR); Saeng Soo YUN, Busan (KR); Hyuk Jae KWON, Busan (KR)

(21) Appl. No.: 14/632,972

(22) Filed: Feb. 26, 2015

(30) Foreign Application Priority Data
Feb. 28, 2014 (KR) 10-2014-0024265
Jun. 13, 2014 (KR) 10-2014-0072029
Jun. 13, 2014 (KR) 10-2014-0072032
Oct. 1, 2014 (KR) 10-2014-0132443

(51) Int. Cl. H02H 9/04; H02H 9/02

(52) U.S. Cl. CPC H02H 9/044; H02H 9/02

(57) ABSTRACT

Disclosed is a complex protection device in which a circuit and circuit elements installed on the circuit may be protected from overcurrent and overvoltage and cohesion of a fusible element is induced by a circular or oval fusing induction part and thus fusing efficiency may be improved.

### BACKGROUND OF THE INVENTION

1. Field of the Invention

The present invention relates to a complex protection device, and more particularly to a complex protection device in which a circuit and circuit elements installed on the circuit may be protected from overcurrent and overvoltage and melting and cohesion of a fusible element are induced by a circular or oval fusing induction part and thus fusing efficiency may be improved.

2. Description of the Related Art

A non-return type protection device, operated in response to excessive heat generated by overcurrent of a protected apparatus or ambient temperature, is operated at a designated temperature and protects an electrical circuit. For example, there is a protection device heating a resistor in response to signal current detecting abnormality of an apparatus and operating a fuse element using generated heat.

Korean Patent Laid-open No. 10-2001-0006916 discloses a protection device in which low melting point metal body electrodes and a heating element are provided on a protection device substrate, a low melting point metal body is formed directly on the low melting point metal body electrodes and the heating element, an inner sealing part formed of a solid flux is installed on the low melting point metal body so as to prevent surface oxidation of the low melting point metal body, and an outer sealing part or a cap to prevent melt from leaking to the outside of the device during fusing of the low melting point metal body is installed on the outer surface of the inner sealing part.

Further, Korean Registered Patent No. 10-1388354 discloses a complex protection device including a fusible element connected to first and second terminals formed on a main circuit and fused if overcurrent is applied to the main circuit, resistive elements connected to resistive terminals connected to the fusible element, and a switching element controlling flow of current to the resistive terminals if voltage deviating from reference voltage is applied, in which the first and second terminals and the resistive terminals are separated from each other in parallel on the same plane and the fusible element is fused by heat generated from the resistive elements if voltage deviating from the reference voltage is applied.

However, in the above Registered Patent, if the fusible element is fused by heat generated from the resistive elements, when the central region of the fusible element is fused in an insufficiently cohered state or the central region of the fusible element is not completely separated from the front end region or the rear end region of the fusible element, current is not intercepted and thus the circuit and circuit elements installed on the circuit are not protected.

Therefore, a complex protection device, in which the central region of a fusible element is effectively cohered during fusing of the fusible element and thus current is completely intercepted, has been required.

### SUMMARY OF THE INVENTION

Therefore, the present invention has been made in view of the above problems, and it is an object of the present invention to provide a complex protection device in which cohesion of a fusible element is induced by a circular or oval fusing induction part disposed just below the fusible element so as to improve fusing efficiency.

It is another object of the present invention to provide a complex protection device in which printed resistive elements installed at both sides of a fusible element generate heat and thus, thermal characteristics may be improved and a circuit and circuit elements installed on the circuit may be protected from overcurrent and overvoltage. It is another object of the present invention to provide a complex protection device in which printed resistive elements are disposed on the lower surface of a substrate so as to more effectively induce melting and cohesion of a fusible element in cooperation with a fusing induction part.

It is another object of the present invention to provide a complex protection device in which printed resistive elements and surface-mounted resistive elements are disposed together and possess resistive terminals jointly so as to effectively induce fusion of a fusible element and to improve space utilization.

It is another object of the present invention to provide a complex protection device in which a fusing induction part and a common connection part are integrated so as to achieve structure simplification.

It is another object of the present invention to provide a complex protection device in which a fusing induction part is formed on a separate third connection terminal so as to implement various circuit patterns.

It is yet another object of the present invention to provide a complex protection device in which a fusing induction part and a common connection part are integrated and printed resistive elements and surface-mounted resistive elements are disposed together so as to effectively induce fusion of a fusible element and to achieve structure simplification.

In accordance with the present invention, the above and other objects can be accomplished by the provision of a complex protection device including a substrate, at least one pair of resistive terminals provided on the substrate, a pair of fuse terminals provided on the substrate, at least one resistive element provided on the at least one pair of resistive terminals, one fusible element provided on the pair of fuse terminals, a fusing induction part disposed just below the central region of the fusible element to concentrate heat, generated from the at least one resistive element, upon the fusible element, and a switching element controlling flow of current to the at least one resistive element if overvoltage is applied, wherein the fusing induction part is formed in a circular or oval shape so that, when the fusible element is melted, the molten fusible element is cohered in the centripetal direction.

The at least one pair of resistive terminals may include first and second resistive terminals, first and second connection terminals connecting the first and second resistive terminals may be provided on the substrate, the first connection terminal or the second connection terminal may include a common connection part disposed just below the fusing induction part, and an insulating layer, including a hole formed at the center thereof so as to connect the fusing induction part and the common connection part by soldering, may be formed between the fusing induction part and the first and second connection terminals.

The at least one pair of resistive terminals may include first and second resistive terminals, first and second connection terminals connecting the first and second resistive terminals may be provided on the substrate, and the first connection terminal or the second connection terminal may include the fusing induction part and a pair of connection parts, each of which has one end connected to the fusing induction part and the other end connected to each of the first and second resistive terminals.

The at least one pair of resistive terminals may include first and second resistive terminals, first and second connection terminals, connecting the first and second resistive terminals, and a third connection terminal, disposed between the first and second connection terminals and provided with one connected to the fusing induction part and the other end connected to the first connection terminal or the second connection terminal, may be provided on the substrate, and an insulating layer, including a hole formed at the center thereof so as to connect the fusing induction part and the fusible element by soldering, may be formed between the fusing induction part and the fusible element.

The at least one pair of resistive terminals may include first and second resistive terminals, first and second connection terminals connecting the first and second resistive terminals may be provided on the substrate, a first insulating layer may be formed on the first and second connection terminals, a conductive layer may be formed on the first insulating layer, the conductive layer may include the fusing induction part disposed at the central region thereof and a conductive part extended from one side of the fusing induction part and connecting the fusible element and the first and second resistive terminals, and the fusing induction part may be formed in a circular or oval shape having a greater width than the conductive part.

The at least one resistive element may be one of a surface-mounted resistive element and a printed resistive element.

The at least one resistive element may include first and second resistive elements disposed on the upper surface of the substrate and a third resistive element disposed on the lower surface of the substrate.

The first and second resistive elements may be installed in parallel at both sides of the fusible element and the third resistive element may be disposed just under the fusible element.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a circuit diagram illustrating a complex protection device in a use state in accordance with the present invention;

FIG. 2 is a plan view illustrating a complex protection device in accordance with one embodiment of the present invention;

FIGS. 3A and 3B are perspective and exploded perspective views illustrating the complex protection device in accordance with the embodiment of the present invention;

FIGS. 4A and 4B are cross-sectional views of FIG. 2 taken along the line A-A and the line B-B;

FIG. 5 is a circuit diagram illustrating fusing of a fusible element if overcurrent is applied to a main circuit;

FIGS. 6 and 7 are a circuit diagram and a plan view illustrating fusing of the fusible element if overvoltage is applied to the main circuit;

FIG. 8 is a cross-sectional view illustrating fusing of the fusible element if overvoltage is applied to the main circuit;

FIG. 9 is a cross-sectional view illustrating a complex protection device in accordance with another embodiment of the present invention;

FIG. 10 is an exploded perspective view illustrating a complex protection device in accordance with yet another embodiment of the present invention;

FIGS. 11A and 11B are perspective and exploded perspective views illustrating the complex protection device in accordance with yet another embodiment of the present invention;

FIGS. 12A and 12B are cross-sectional views of FIG.11A and 11B;

FIG. 13 is exploded perspective views illustrating the complex protection device in accordance with yet another embodiment of the present invention;

FIGS. 14A and 14B are perspective and exploded perspective views illustrating the complex protection device in accordance with yet another embodiment of the present invention; and

FIGS. 15A and 15B are cross-sectional views of FIG. 14A taken along the line A-A and the line B-B.

### DETAILED DESCRIPTION OF THE INVENTION

Hereinafter, preferred embodiments of the present invention will be described in detail with reference to the annexed drawings.

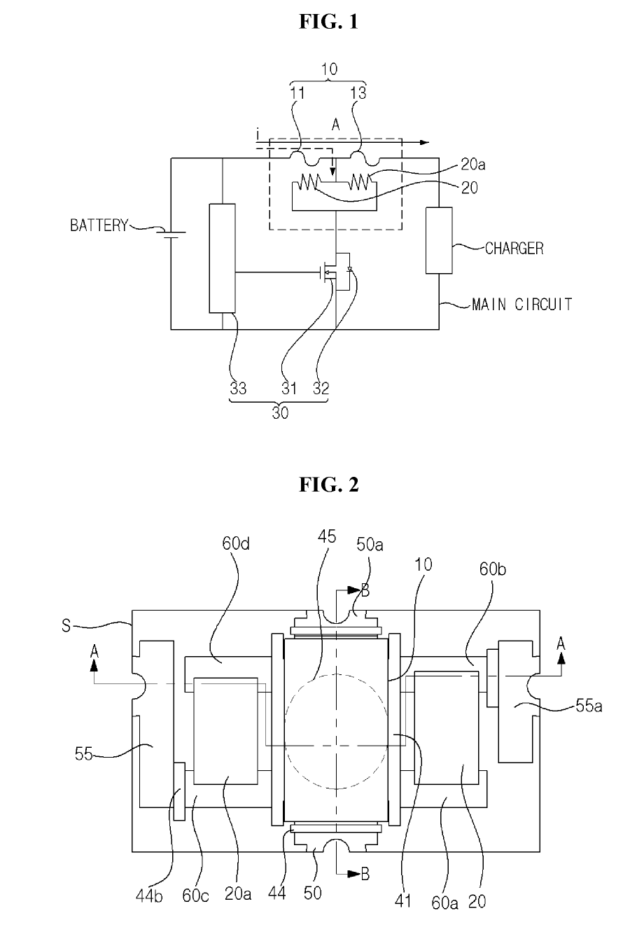

With reference to FIG. 1, a complex protection device in accordance with the present invention serves to protect a circuit and elements connected to a main circuit in an abnormal state by fusing of a fusible element 10 connected to the main circuit.

The main circuit to which the complex protection device in accordance with the present invention is applied is not limited as to kind and, for example, the main circuit may be a charging circuit in which charging of a battery is performed.

The fusible element 10 and a battery are connected and a charger and the fusible element 10 are connected on the main circuit. In more detail, a plurality of resistive elements 20 and 20a connected to the fusible element 10 and a switching element 30 connected to the plurality of resistive elements 20 and 20a may be provided on the main circuit.

The switching element 30 may exemplarily include a diode 32, a transistor 31, and a controller 33 applying a control signal to turn the transistor 31 on so as to control current flow to the resistive elements 20 and 20a if overvoltage is applied.

First, if overcurrent is applied to the main circuit, the fusible element 10 is fused by heat generated by such overcurrent flowing the fusible element 10 and thus protects the circuit and circuit elements.

Further, if overvoltage is applied to the main circuit, the fusible element 10 is fused by heat generated from the resistive elements 20 and 20a and thus protects the circuit and the circuit elements.

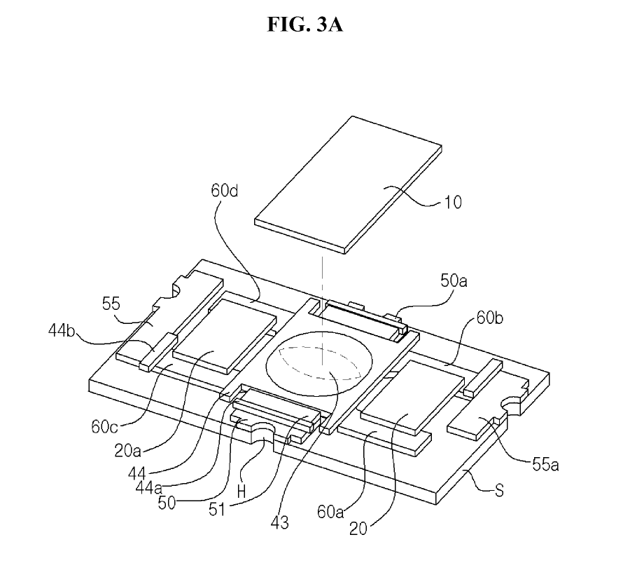

With reference to FIGS. 2 to 4B, the complex protection device in accordance with the present invention includes a substrate S and the fusible element 10 and first and second printed resistive elements 20 and 20a are installed on the substrate S.

Further, fuse terminals 50 and 50a to which the fusible element 10 is connected, first resistive terminals 60a and 60b to which the first printed resistive element 20 is connected, second resistive terminals 60c and 60d to which the second printed resistive element 20a is connected, first and second connection terminals 70 and 70a connecting the first and second resistive terminals 60a, 60b, 60c, and 60d, terminals 55, 55a, and a terminal hole H are formed on the substrate S. Further, an insulating layer 41, a fusing induction part 45, and the fusible element 10 are sequentially stacked on the first and second connection terminals 70 and 70a. The terminal hole H serves to electrically connect the main circuit and the complex protection device.

Connection pieces 51 may be formed on the fuse terminals and 50a. Since the fusible element 10 is disposed on the insulating layer 41 and the fusing induction part 45, a height difference is formed between the fusible element 10 and the fuse terminals 50 and 50a. Therefore, the connection pieces 51 serve to connect the fusible element 10 and the fuse terminals 50 and 50a.

The fuse terminals 50 and 50a, the first resistive terminals 60a and 60b, and the second resistive terminals 60c and 60d are installed so as to be separated from each other on the same plane.

The first connection terminal 70 serves to electrically connect the first resistive terminal 60a and the second resistive terminal 60c.

The second connection terminal 70a may include a circular or oval common connection part 71 disposed at the center thereof and a pair of connection parts 73 formed at both sides of the common connection part 71 so as to connect the first resistive terminal 60b and the second resistive terminal 60d.

The common connection part 71 is disposed just below the fusing induction part 45 and serves to conduct a part of heat generated from the resistive elements 20 and 20a to the fusible element 10.

The connection parts 73 have a structure bent from the resistive elements 60b and 60d toward the common connection part 71 and allows the fuse terminal 50a to be disposed in a space between the two connection parts 73, thus contributing to miniaturization. That is, the first connection terminal 70 and the second connection terminal 70a are disposed between the fuse terminals 50 and 50a and a pair of connection parts 73 are bent from the respective resistive terminals 60b and 60d toward the center of the second connection terminal 70a so that the interval between the fuse terminals 50 and 50a may be reduced and thus miniaturization may be realized. Further, the second connection terminal 70a includes the common connection part 71 disposed just below the fusing induction part 45 and the common connection part 71 has a shape and area corresponding to the fusing induction part 45 and may thus effectively transmit heat generated from the resistive elements 20 and 20a to the fusing induction part 45.

The first and second printed resistive elements 20 and 20a serving to generate heat and then to fuse the fusible element 10 if overvoltage is applied to the main circuit may be disposed at both sides of the fusible element 10.

The amount of heat generated from the printed resistive elements 20 and 20a increases in proportion to the area thereof.

A conventional complex protection device includes a pair of terminals at both sides of a substrate. On the other hand, in the present invention, current is branched at the common connection part 71 and flows to the first and second printed resistive elements 20 and 20a, and an area allocated to the resistive elements 20 and 20a is increased and thus the size of the resistive elements 20 and 20a may be increased by 30%, as compared to the conventional complex protection device, or the size of the substrate may be reduced.

Further, since the first and second printed resistive elements 20 and 20a are formed of a thin film printed directly on the first and second resistive terminals 60a, 60b, 60c, and 60d and the substrate S without a lead wire, an automation process may be easily applied to the first and second printed resistive elements 20 and 20a and the first and second printed resistive elements 20 and 20a may be small-sized, as compared to surface-mounted resistive elements, and reduce manufacturing costs and installation costs.

A protection film (not shown) may be formed on the surfaces of the printed resistive elements 20 and 20a. The reason for this is that, when the printed resistive elements 20 and 20a are exposed to moisture, the printed resistive elements 20 and 20a do not perform the function thereof or have a reduced lifespan and thus, if parts of the printed resistive elements 20 and 20a exposed to the outside are shielded by the protection film, these problems caused by moisture may be prevented. The protection film may be formed by printing the surfaces of the printed resistive elements 20 and 20a with a polymer resistant to moisture.

Further, the insulating layer 41, the fusing induction part 45, and the fusible element 10 are sequentially stacked on the first and second connection terminals 70 and 70a.

The insulating layer 41 may include a plate-shaped insulation part 42 and first interception films 44.

The insulation part 42 serves to prevent the fusible element 10 from being connected to the connection terminals 70 and 70a and includes a hole 43 through which the fusing induction part 45 and the common connection part 71 are connected by soldering.

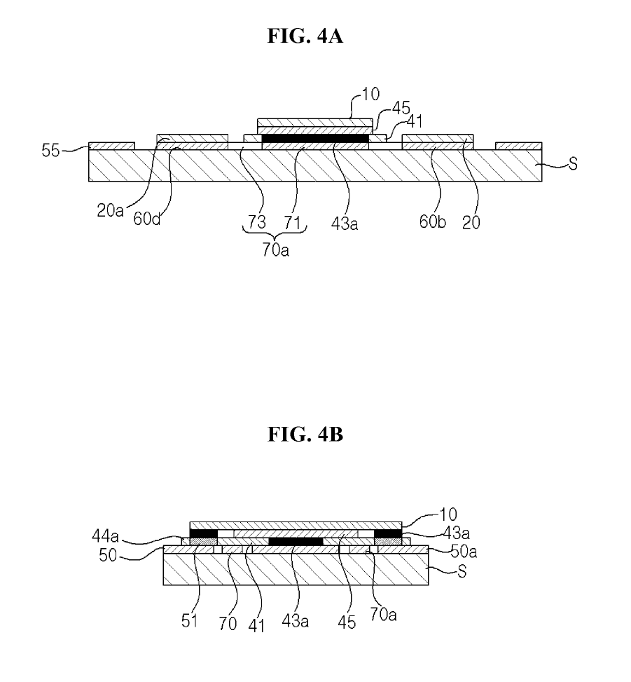

With reference to FIG. 4A, the hole 43 may be disposed just below the fusing induction part 45 and have a circular or oval shape, and the inside of the hole 43 is filled with solder 43a so as to electrically connect the fusing induction part 45 and the common connection part 71.

The first interception films 44 prevent the molten solder 43a from moving to the left and right during soldering of the fusible element 10 and a pair of first interception films 44 may be formed at both sides of each of the front and rear ends of the isolation part 42.

In the same manner as the first interception films 44, a pair of second interception films 44a preventing the molten solder 43a from moving during soldering of the fusible element 10 may be formed on the fuse terminals 50 and 50a.

When the solder 43a applied to the fuse terminals 50 and 50a is melted and moves during soldering of the fusible element 10, the fusible element 10 placed on the solder 43a is moved together and thus a defect occurs. Therefore, by installing the first and second interception films 44 and 44a around the fusible element 10, movement of the solder 43a is prevented and the position of the fusible element 10 is fixed. Further, although not shown in the drawings, the height of the first and second interception films 44 and 44a may be higher than the height of the lower surface of the fusible element 10 so that the fusible element 10 may be fixed regardless of movement of the solder 43a.

The fusing induction part 45 may be formed in a circular or oval shape so as to induce melting and cohesion of the fusible element 10 to effectively fuse the fusible element 10.

Concretely, the fusing induction part 45 is disposed between the fusible element 10 and the common connection part 71 and serves to electrically connect the fusible element 10 and the common connection part 71 and to transmit heat conducted through the common connection part 71 to the fusible element 10. The fusing induction part 45 may have a length (diameter) corresponding to the width of the fusible element 10.

The fusible element 10 is connected to the fuse terminals 50 and 50a, and is fused to protect the circuit and the circuit elements when overcurrent is applied to the main circuit.

The fusible element 10 may be exemplarily formed of a metal or an alloy having a melting point of 120-300° C.

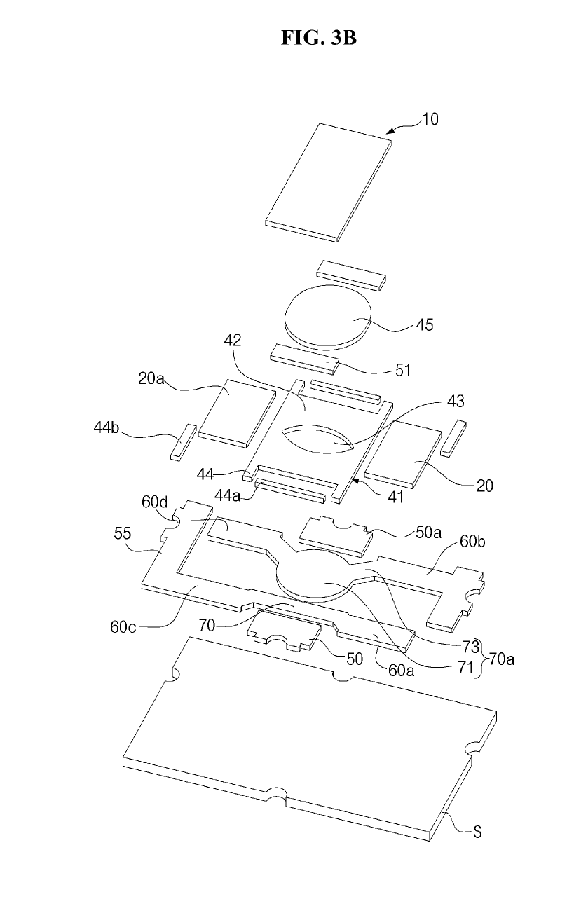

With reference to FIG. 3B and 4A, current applied to the fusible element 10 flows to the common connection part 71 via the fusing induction part 45, is branched off to the first resistive terminals 60a and 60b and the second resistive terminals 60c and 60d at the common connection part 71, and is then joined at the terminal 55.

Further, the first and second printed resistive elements and 20a located at both sides of the fusible element 10 generate heat, and such heat, assuming the form of radiant heat, heats the fusible element 10 and, assuming the form of conductive heat, heats the fusible element 10 through the common connection part 71 and the fusing induction part 45 and fuses the fusible element 10.

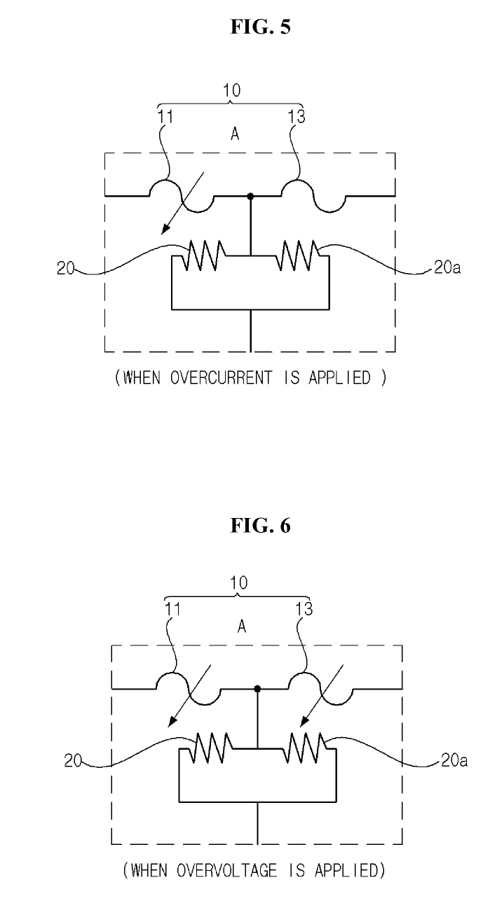

With reference to FIG. 5, the fusible element 10 is fused by heat generated therefrom if surge current is momentarily applied to the main circuit or if overcurrent is continuously applied to the main circuit.

Here, since a front end region 11 of the fusible element is fused and the main circuit is interrupted, damage or explosion of the main circuit is prevented.

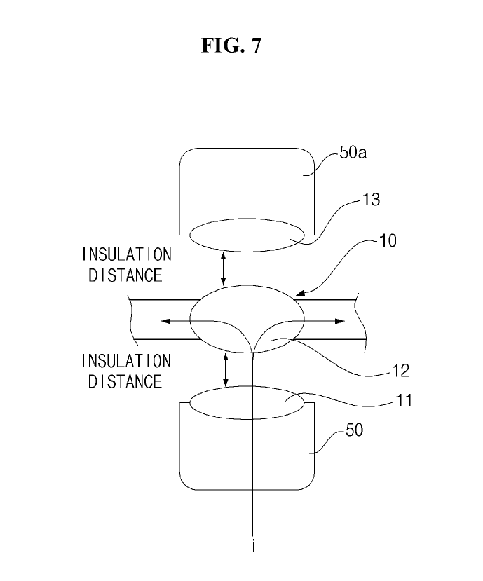

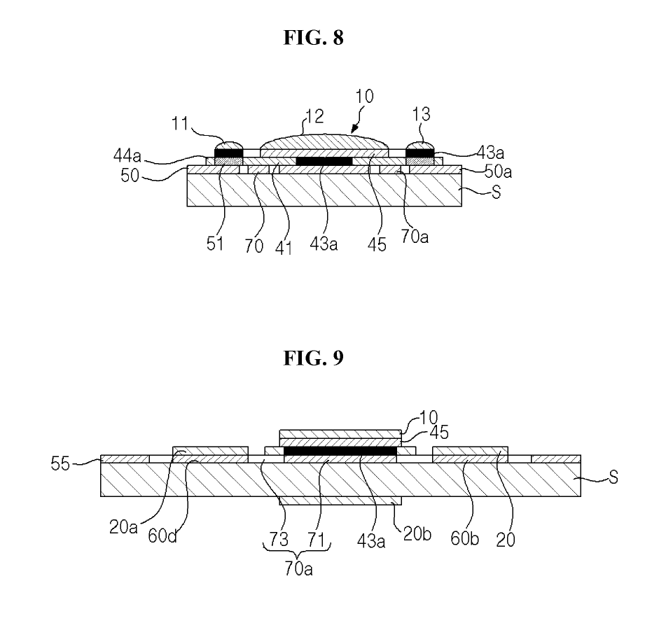

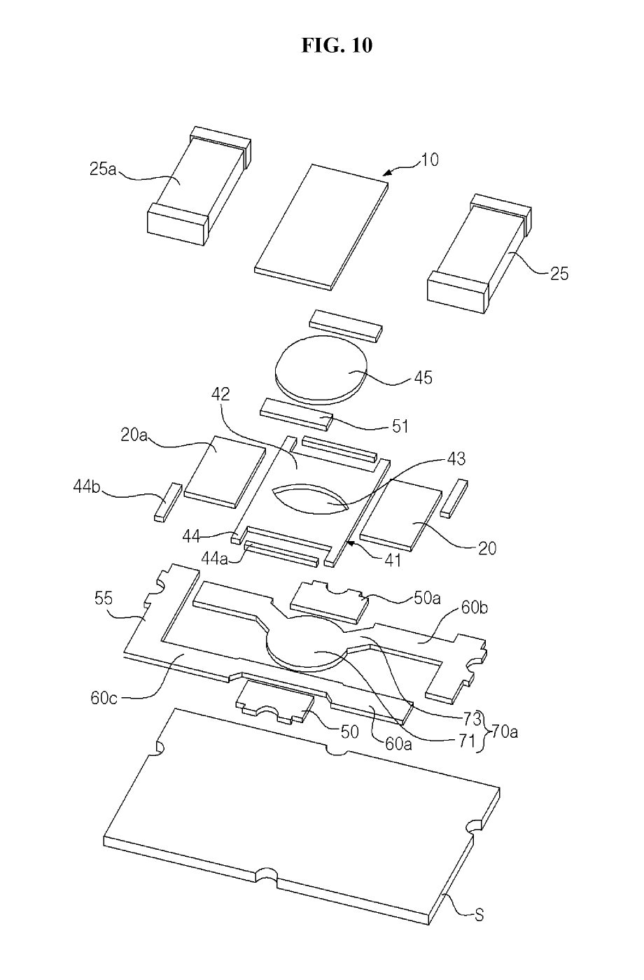

With reference to FIGS. 6 to 8, if overvoltage deviating from reference voltage is applied to the main circuit, as described above, the switching element 30 controls flow of current to the first and second resistive elements 20 and 20a (with reference to FIG. 1).

The fusible element 10 includes a middle region 12 contacting the fusing induction part 45 and front and rear end regions 11 and 13 extended forwards and backwards from the middle region 12, and at least one of the front end region 11 and the rear end region 13 is fused by heat generated from the first and second printed resistive elements 20 and 20a by current introduced to the first and second printed resistive elements 20 and 20a and thus protects the circuit.

In more detail, in the fusible element 10, the middle region 12 is heated by conductive heat as well as radiant heat and thus receives a larger amount of heat than the front end region 11 and the rear end region 13 which do not directly contact the fusing induction part 45 (with reference to FIG. 3A).

Therefore, when the fusible element 10 is heated, the middle region 12 is melted earlier than the front end region 11 and the rear end region 13, is cohered by surface tension, and is then separated from the front end region 11 and the rear end region 13.

Here, if the fusing induction part 45 is formed in a circular shape or an oval shape, uniform molecular force acts on the molten middle region 12 on the circular fusing induction part 45 in the centripetal direction and thus cohesive force increases and the middle region 12 is effectively separated from the front end region 11 and the rear end region 13.

As described above, in this embodiment of the present invention, the circular or oval fusing induction part 45 is disposed just below the fusible element 10 and may thus effectively induce melting and cohesion of the fusible element 10.

Hereinafter, another embodiment of the present invention will be described with reference to the accompanying drawings.

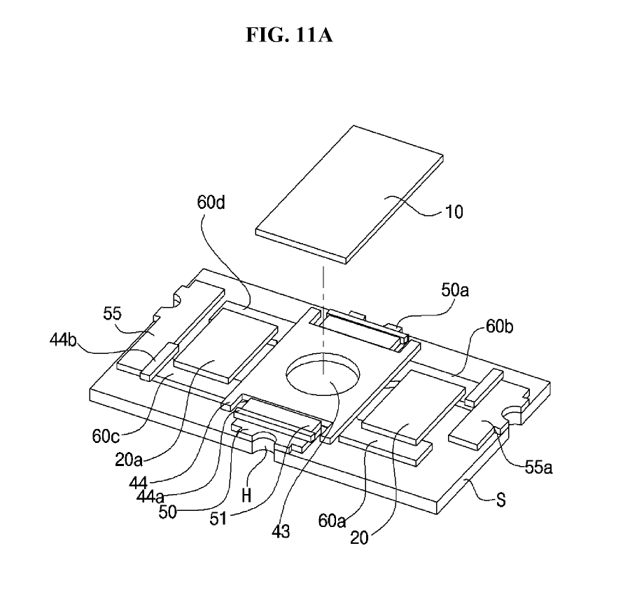

With reference to FIG. 9, a complex protection device in accordance with this embodiment includes two, i.e., first and second, printed resistive elements 20 and 20a disposed on the upper surface of a substrate S, in the same manner as the complex protection device in accordance with the former embodiment shown in FIGS. 2 to 8. Therefore, some parts in this embodiment which are substantially the same as those in the former embodiment are denoted by the same reference numerals even though they are depicted in different drawings and a detailed description thereof will thus be omitted because it is considered to be unnecessary. The complex protection device in accordance with this embodiment further includes a third printed resistive element 20b disposed on the lower surface of the substrate S, differently from the complex protection device in accordance with the former embodiment.

A resistive element (not shown) to which the third printed resistive element 20b is connected is formed on the lower surface of the substrate S.

The first and second printed resistive elements 20 and 20a are installed in parallel at both sides of a fusible element 10, and the third printed resistive element 20b disposed just below the fusible element 10 such that the substrate S is located between the fusible element 10 and the third printed resistive element 20b.

Therefore, the first, second, and third printed resistive elements 20, 20a, and 20b simultaneously generate heat at both sides of the fusible element 10 and under the fusible element 10 and fusing efficiency may thus be increased.

Further, if the complex protection device of the present invention is used for high power, printed resistive elements need to have a wide area so as to secure a sufficient amount of generated heat and then the printed resistive elements may be damaged by overheating. In this case, the third printed resistive element 20b in accordance with this embodiment is installed and divisionally generates heat and thus durability of the printed resistive elements may be improved.

As described above, in this embodiment of the present invention, the printed resistive element 20b is disposed on the lower surface of the substrate and may thus more effectively induce melting and cohesion of the fusible element 10.

Hereinafter, another embodiment of the present invention will be described with reference to the accompanying drawings.

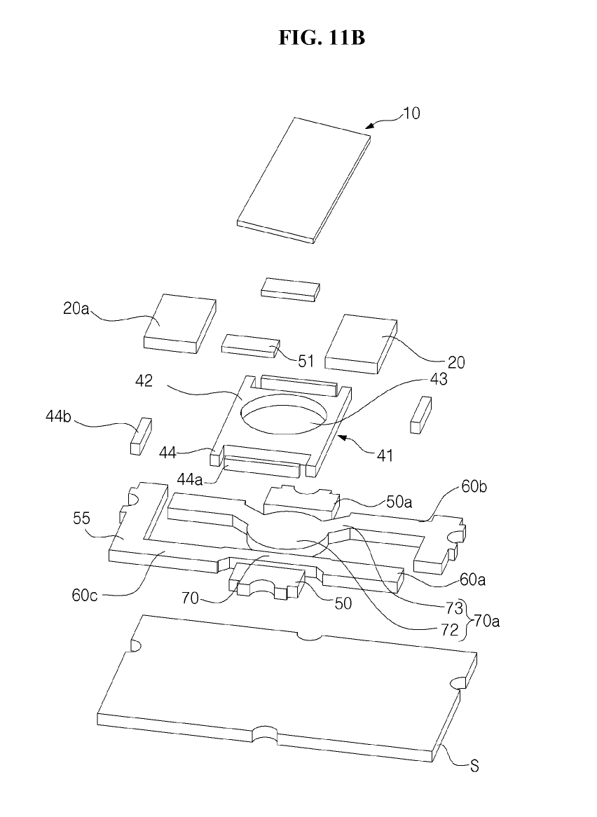

With reference to FIG. 10, a complex protection device in accordance with this embodiment includes first and second printed resistive elements 20 and 20a installed in parallel at both sides of a fusible element 10, in the same manner as the complex protection device in accordance with the former embodiment shown in FIGS. 2 to 8. However, the complex protection device in accordance with this embodiment further includes surface-mounted resistive elements 25 and 25a, differently from the complex protection device in accordance with the former embodiment. Here, the surface-mounted resistive elements 25 and 25a and the printed resistive elements 20 and 20a may have the same resistance value or different resistance values.

The surface-mounted resistive elements 25 and 25a may include a first surface-mounted resistive element 25 disposed on the first printed resistive element 20 and a second surface-mounted resistive element 25a disposed on the second printed resistive element 25a.

The first and second surface-mounted resistive elements 25 and 25a may be respectively connected to first resistive elements 60a and 60b, and second resistive elements 60c and 60d in the same manner as the first and second printed resistive elements 20 and 20a.

As described above, the surface-mounted resistive elements and the printed resistive elements are disposed together and possess the resistive terminals jointly and may thus effectively induce fusion of the fusible element and improve space utilization.

In the same manner as the former embodiment shown in FIGS. 2 to 8, the complex protection device in accordance with this embodiment may include first and second interception films 44 and 44a and additionally include third interception films 44b disposed at one side of each of the resistive terminals 60b and 60c so as to prevent movement of solder 43a during soldering of the first and second surface-mounted resistive elements 25 and 25a. The third interception films 44b prevent the first and second surface-mounted resistive elements 25 and 25a from being moved together with the molten solder 43.

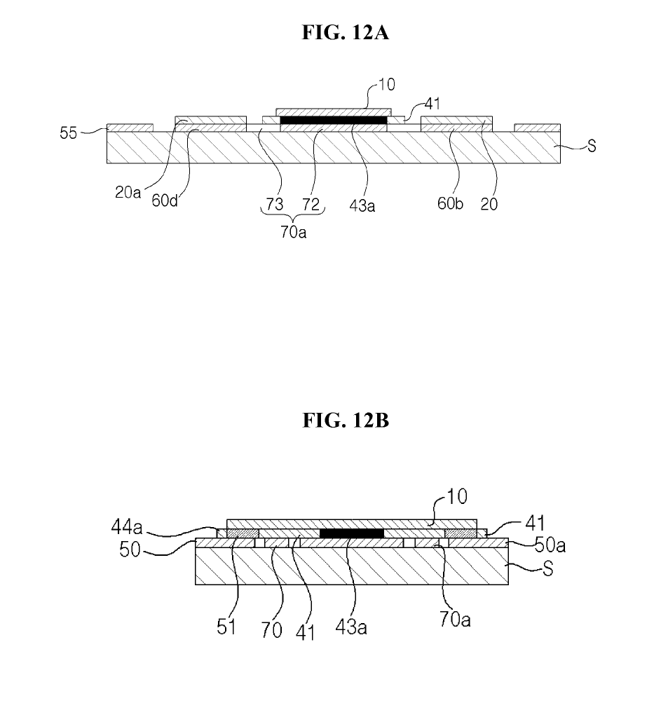

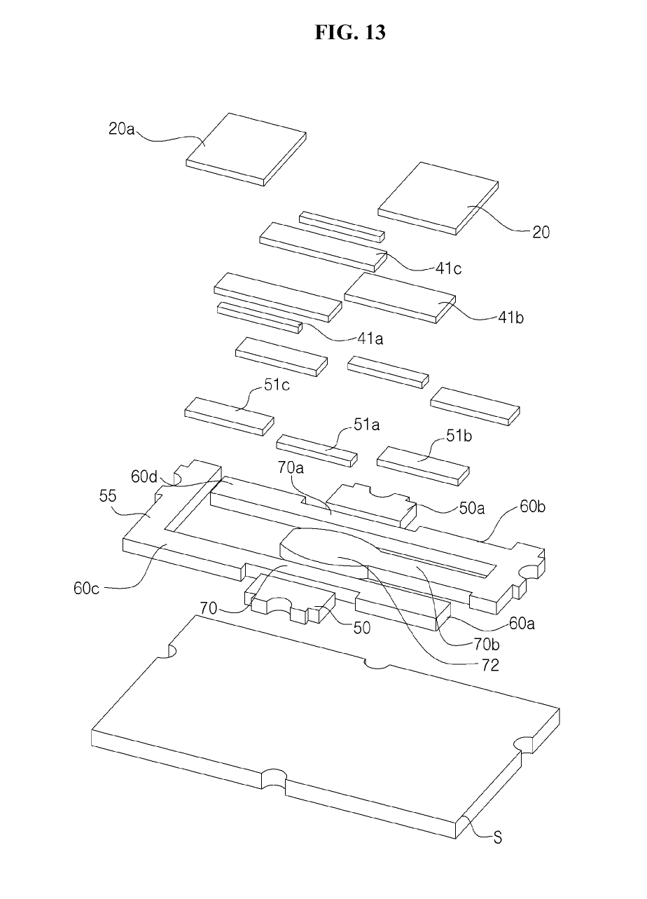

With reference to FIGS. 11A to 12B, the complex protection device in accordance with the present invention includes a substrate S and the fusible element 10 and first and second printed resistive elements 20 and 20a are installed on the substrate S.

Further, fuse terminals 50 and 50a to which the fusible element 10 is connected, first resistive terminals 60a and 60b to which the first printed resistive element 20 is connected, second resistive terminals 60c and 60d to which the second printed resistive element 20a is connected, first and second connection terminals 70 and 70a connecting the first and second resistive terminals 60a, 60b, 60c, and 60d, terminals 55, 55a, and a terminal hole H are formed on the substrate S. Further, an insulating layer 41 and the fusible element 10 are sequentially stacked on the first and second connection terminals 70 and 70a. The terminal hole H serves to electrically connect the main circuit and the complex protection device.

Connection pieces 51 may be formed on the fuse terminals and 50a. Since the fusible element 10 is disposed on the insulating layer 41, a height difference is formed between the fusible element 10 and the fuse terminals 50 and 50a. Therefore, the connection pieces 51 serve to connect the fusible element 10 and the fuse terminals 50 and 50a.

The fuse terminals 50 and 50a, the first resistive terminals 60a and 60b, and the second resistive terminals 60c and 60d are installed so as to be separated from each other on the same plane.

The first connection terminal 70 serves to electrically connect the first resistive terminal 60a and the second resistive terminal 60c.

The second connection terminal 70a may include a circular or oval fusing induction part 72 disposed at the center thereof and a pair of connection parts 73 formed at both sides of the fusing induction part 72 so as to connect the first resistive terminal 60b and the second resistive terminal 60d.

The fusing induction part 72 is disposed just below a central region 12 of the fusible element 10 and a hole 43 which will be described later and serves to conduct a part of heat generated from the resistive elements 20 and 20a to the fusible element 10 and to induce melting and cohesion of the fusible element 10. The fusing induction part 72 may be formed in a circular or oval shape so as to effectively fuse the fusible element 10.

The connection parts 73 have a structure bent from the resistive elements 60b and 60d toward the fusing induction part 72 and allows the fuse terminal 50a to be disposed in a space between the two connection parts 73, thus contributing to miniaturization. That is, the first connection terminal 70 and the second connection terminal 70a are disposed between the fuse terminals 50 and 50a and a pair of connection parts 73 are bent from the respective resistive terminals 60b and 60d toward the center of the second connection terminal 70a so that the interval between the fuse terminals 50 and 50a may be reduced and thus miniaturization may be realized.

The first and second printed resistive elements 20 and 20a serving to generate heat and then to fuse the fusible element 10 if overvoltage is applied to the main circuit may be disposed at both sides of the fusible element 10.

Further, the insulating layer 41 and the fusible element 10 are sequentially stacked on the first and second connection terminals 70 and 70a.

The insulating layer 41 may include a plate-shaped insulation part 42 and first interception films 44. _p The insulation part 42 serves to prevent the fusible element 10 from being connected to the connection terminals 70 and 70a and includes a hole 43 through which the fusible element 10 and the fusing induction part 72 are connected by soldering.

Current applied to the fusible element 10 flows to the fusing induction part 72, is branched off to the first resistive terminals 60a and 60b and the second resistive terminals 60c and 60d at the fusing induction part 72 via the connection parts 73, and is then joined at the terminal 55.

Further, the first and second printed resistive elements and 20a located at both sides of the fusible element 10 generate heat, and such heat, assuming the form of radiant heat, heats the fusible element 10 and, assuming the form of conductive heat, heats the fusible element 10 through the fusing induction part 72 and fuses the fusible element 10.

As described above, in this embodiment of the present invention, the fusing induction part and the common connection part are integrated and may thus achieve structure simplification.

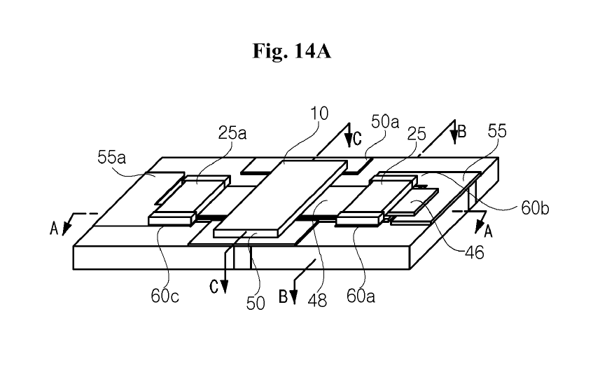

With reference to FIG. 13, the complex protection device in accordance with this embodiment includes first and second printed resistive elements 20 and 20a installed in parallel at both sides of a fusible element 10.

And, the complex protection device in accordance with this embodiment differs from the complex protection device in accordance with the former embodiment in that a fusing induction part 72 is not connected to a second connection terminal 70a but is formed between first and second connection terminals 70 and 70a so as to be separated from the first and second connection terminals 70 and 70a, a third connection terminal 70b is disposed between first and second resistive element 60a and 60b, and an insulating layer is not formed integrally but is divided into first, second, and third insulation parts 41a, 41b, and 41c.

One end of the third connection terminal 70b is connected to the fusing induction part 72 and the other end of the third connection terminal 70b is connected to the first resistive terminal 60b, and heat generated from the first and second printed resistive elements 20a and 20b is conducted to the fusible element 10 via the second connection terminal 70a, the third connection terminal 70b, and the fusing induction part 72.

Further, current applied to the fusible element 10 is branched off to the first resistive terminals 60a and 60b and the second resistive terminals 60c and 60d at the fusing induction part 72 and is then joined at the terminal 55.

As described above, in this embodiment of the present invention, the fusing induction part is formed on the separate third connection terminal and may thus implement various circuit patterns.

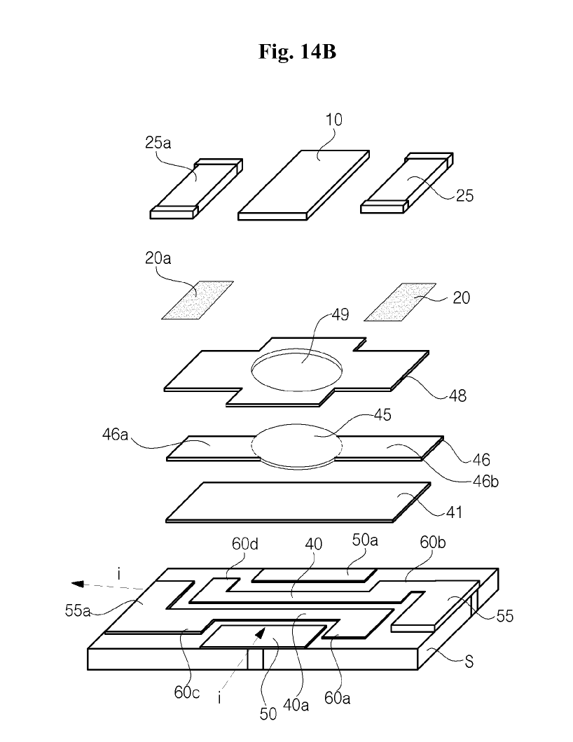

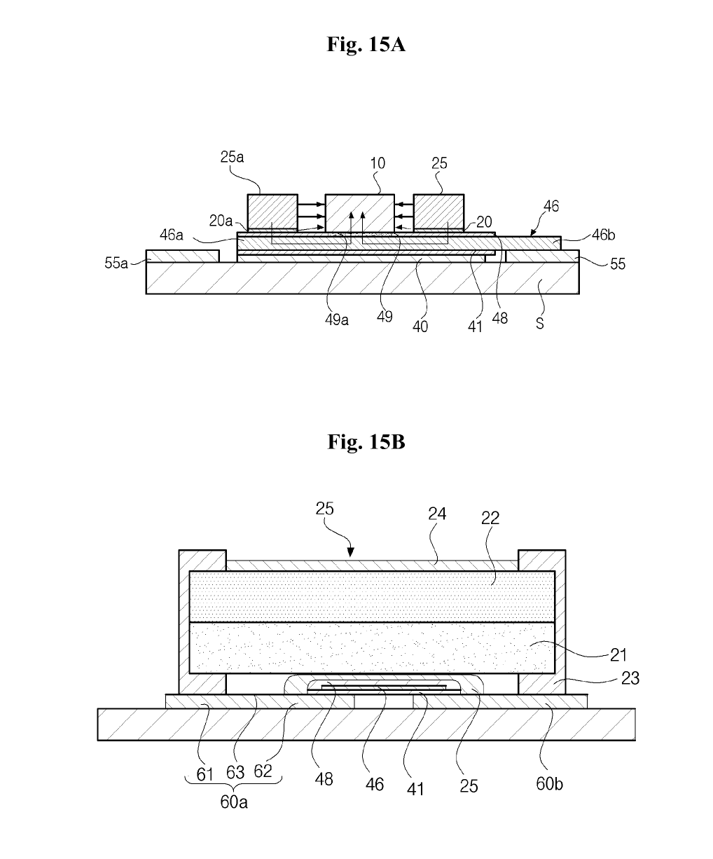

With reference to FIGS. 14A to 15B, the complex protection device in accordance with the present invention includes a substrate S on which the fusible element 10, the resistive elements 20, 20a, 25, and 25a, and the switching element 30 are installed. The resistive elements 20, 20a, 25, and 25a include surface-mounted resistive elements 20 and 20a and printed resistive elements 25 and 25a.

In order to install the fusible element 10 and the resistive elements 20, 20a, 25, and 25a on the substrate S, fuse terminals 50 and 50a, first resistive terminals 60a and 60b, second resistive terminals 60c and 60d, first and second connection terminals 40 and 40a, and first and second terminals 55 and 55a are formed on the substrate S.

The fuse terminals 50 and 50a, the first resistive terminals 60a and 60b, and the second resistive terminals 60c and 60d are installed so as to be separated from each other on the same plane.

The fusible element 10 is installed on the fuse terminals 50 and 50a.

A first surface-mounted resistive element 25 and a first printed resistive element 20 are installed on the first resistive terminals 60a and 60b, and a second surface-mounted resistive element 25a and a second printed resistive element 20a are installed on the second resistive terminals 60c and 60d.

The first and second connection terminals 40 and 40a serve to connect the first resistive terminals 60a and 60b and the second resistive terminals 60c and 60d. The first connection terminal 40 connects the first resistive terminal 60b and the second resistive terminal 60d, and the second connection terminal 40a connects the first resistive terminal 60a and the second resistive terminal 60c.

The first terminal 55 is connected to the first resistive terminal 60b, and the second terminal 55a is connected to the second resistive terminal 60c.

The fusible element 10 is connected to the fuse terminals and 50a, and is broken and protects the circuit and the circuit elements if overcurrent is applied to the main circuit.

The fusible element 10 may be exemplarily formed of a metal or an alloy having a melting point of 120-300° C.

The first and second surface-mounted resistive elements 25 and 25a generate heat and thus serve to break the fusible element 10 if overvoltage is applied. The first and second surface-mounted resistive elements 25 and 25a may be disposed at both sides of the fusible element 10.

The first and second printed resistive elements 20 and 20a generate heat and thus serve to provide such heat to the fusible element 10 if overvoltage is applied, in the same manner as the first and second surface-mounted resistive elements 25 and 25a.

The first and second printed resistive elements 20 and 20a may be disposed under the first and second surface-mounted resistive elements 25 and 25a, in more detail, in spaces formed among both terminal parts 23 and the element bodies 21.

A first insulating layer 41, a conductive layer 46, and a second insulating layer 48 are sequentially stacked on the first and second connection terminals 40 and 40a.

The first insulating layer 41 serves to electrically isolate the first and second connection terminals 40 and 40a and the conductive layer 46 from each other.

The conductive layer 46 serves to electrically connect the fusible element 10 to the first and second surface-mounted resistive elements 25 and 25a and the first and second printed resistive elements 20 and 20a, and is configured such that one end of the conductive layer 46 is connected to the first terminal 55 and connection of the other end of the conductive layer 46 to the second terminal 55a is interrupted. Further, the conductive layer 46 may be formed by applying a silver (Ag) paste to the upper surface of the first insulating layer 41.

The conductive layer 46 may include a breaking induction part 45, a conductive part 46b extended from one side of the breaking induction part 45 and electrically connecting the fusible element 10 and the first surface-mounted resistive element 20 through the first terminal 55, and a heat transfer part 46a extended from the other side of the breaking induction part 45 and physically contacting the second surface-mounted resistive element 25a.

The breaking induction part 45 means a region of the conductive layer 46 installed just under the fusible element 10, and serves to induce melting and cohesion of the fusible element 10 melted by heat generated from the first and second surface-mounted resistive elements 25 and 25a.

Further, the breaking induction part 45 may have a greater width than the conductive part 46b and the heat transfer part 46a and protrude in the lengthwise direction of the fusible element 10.

The second insulating layer 48 serves to electrically isolate the conductive layer 46 and the first and second surface-mounted resistive elements 25 and 25a and printed resistive elements 20 and 20a.

The fusible element 10, the first and second surface-mounted resistive elements 25 and 25a, and the first and second printed resistive elements 20 and 20a are installed on the second insulating layer 48.

A hole 49 is formed on the second insulating layer 48 so that the fusible element 10 and the conductive layer 46, particularly, the breaking induction part 45, may be connected through the hole 49.

The hole 49 may be formed to have size and shape corresponding to the breaking induction part 45.

The breaking induction part 45 of the conductive layer 46 is exposed through the hole 49 and is connected to the fusible element 10 by applying a conductive material, such as a solder paste 49a, to the exposed surface of the breaking induction part 45.

If overvoltage is applied to the main circuit, current flows in order of the fusible element 10, the conductive layer 46 and the first terminal 55.

Current applied to the fusible element 10 is branched off in the middle of the fusible element 10 and flows to the first terminal 55 via the conductive layer 46. Current applied to the first terminal 55 passes through the first and second surface-mounted resistive elements 25 and 25a which are connected in parallel using the first and second connection terminals 40 and 40a and then flows to the second terminal 55a. Since the first printed resistive element 25 possess the first resistive terminals 60a and 60b in common with the first surface-mounted resistive element 25 and the second printed resistive element 20a possess the second resistive terminals 60c and 60d in common with the second surface-mounted resistive element 25a, the first and second surface-mounted resistive elements 25 and 25a are connected in parallel and the first and second printed resistive elements 20 and 20a are connected in parallel, and current applied to the first terminal 55 is branched off, flows to the first and second surface-mounted resistive elements 25 and 25a and the first and second printed resistive elements 20 and 20a, and then joins at the second terminal 55a.

Both the first surface-mounted resistive element 25 and the first printed resistive element 20 are connected to the first resistive terminals 60a and 60b. Each of the first resistive terminals 60a and 60b may include a surface-mounted resistive terminal part 61 to which the first surface-mounted resistive element 25 is connected, a printed resistive terminal part 62 to which the first printed resistive element 20 is connected, and a connection part 63 connecting the surface-mounted resistive terminal part 61 and the printed resistive terminal part 62.

As described above, in this embodiment of the present invention, the fusing induction part and the common connection part are integrated and the surface-mounted resistive elements and the printed resistive elements disposed together and may thus effectively induce fusion of the fusible element and achieve structure simplification.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A complex protection device comprising:
a substrate;
at least one pair of resistive terminals provided on the substrate;
a pair of fuse terminals provided on the substrate;
at least one resistive element provided on the at least one pair of resistive terminals;
one fusible element provided on the pair of fuse terminals;
a fusing induction part disposed just below the central region of the fusible element to concentrate heat, generated from the at least one resistive element, upon the fusible element; and
a switching element controlling flow of current to the at least one resistive element if overvoltage is applied,
wherein the fusing induction part is formed in a circular or oval shape so that, when the fusible element is melted, the molten fusible element is cohered in the centripetal direction.

2. The complex protection device according to claim 1, wherein:
the at least one pair of resistive terminals includes first and second resistive terminals;
first and second connection terminals connecting the first and second resistive terminals are provided on the substrate;
the first connection terminal or the second connection terminal includes a common connection part disposed just below the fusing induction part; and
an insulating layer, including a hole formed at the center thereof so as to connect the fusing induction part and the common connection part by soldering, is formed between the fusing induction part and the first and second connection terminals.

3. The complex protection device according to claim 1, wherein:
the at least one pair of resistive terminals includes first and second resistive terminals;
first and second connection terminals connecting the first and second resistive terminals are provided on the substrate; and
the first connection terminal or the second connection terminal includes the fusing induction part and a pair of connection parts, each of which has one end connected to the fusing induction part and the other end connected to each of the first and second resistive terminals.

4. The complex protection device according to claim 1, wherein:
the at least one pair of resistive terminals includes first and second resistive terminals;
first and second connection terminals, connecting the first and second resistive terminals, and a third connection terminal, disposed between the first and second connection terminals and provided with one connected to the fusing induction part and the other end connected to the first connection terminal or the second connection terminal, are provided on the substrate; and
an insulating layer, including a hole formed at the center thereof so as to connect the fusing induction part and the fusible element by soldering, is formed between the fusing induction part and the fusible element.

5. The complex protection device according to claim 1, wherein:
the at least one pair of resistive terminals includes first and second resistive terminals;
first and second connection terminals connecting the first and second resistive terminals are provided on the substrate;
a first insulating layer is formed on the first and second connection terminals; and
a conductive layer is formed on the first insulating layer, wherein:
the conductive layer includes the fusing induction part disposed at the central region thereof and a conductive part extended from one side of the fusing induction part and connecting the fusible element and the first and second resistive terminals; and
the fusing induction part is formed in a circular or oval shape having a greater width than the conductive part.

6. The complex protection device according to claim 1, wherein the at least one resistive element is one of a surface-mounted resistive element and a printed resistive element.

7. The complex protection device according to claim 6, wherein the at least one resistive element includes first and second resistive elements disposed on the upper surface of the substrate and a third resistive element disposed on the lower surface of the substrate.

8. The complex protection device according to claim 7, wherein the first and second resistive elements are installed in parallel at both sides of the fusible element and the third resistive element is disposed just under the fusible element.
